(19) United States
(12) Patent Application Publication
(10) Pub. No.: US 2025/0312767 A1
(43) Pub. Date: Oct. 9, 2025

(54) PRODUCTION LINE FOR MANUFACTURING NON-METALLIC COMPOSITE REINFORCING MESH

(71) Applicant: LIMITED LIABILITY COMPANY COMPOSITE GROUP CHELYABINSK, Chelyabinsk (RU)

(72) Inventor: Oleg Yurievich BELIAEV, Chelyabinsk (RU)

(21) Appl. No.: 18/865,353

(22) PCT Filed: Dec. 14, 2022
(86) PCT No.: PCT/RU2022/050393

§ 371 Date: Nov. 13, 2024

(30) Foreign Application Priority Data
May 25, 2022 (RU) 2022114101

(51) Int. Cl. B01J 19/18; B01J 19/00; C08J 5/24

(52) U.S. Cl. CPC B01J 19/18; B01J 19/0013; C08J 5/24; B01J 2219/00074

(57) ABSTRACT

The invention refers to technological equipment used to produce FRP rebar mesh for reinforcing concrete products, masonry and brickwork. The technical result is an increase in the degree of automation of the production process and exclusion of technological stops aimed at replacing materials to manufacture transvers rods of FRP mesh. The technological line for non-metallic FRP mesh production (that includes sequentially installed roving rack with bobbins of roving, an impregnation and pressing unit, a FRP mesh forming and weaving device, a polymerization chamber, a water cooling unit, a FRP mesh pulling unit and a cutting unit) has, installed behind the water cooling unit, a return wheel mounted on a frame which is able to receive one to six bars used as FRP mesh transverse rods that move parallel to the roving strands intended for longitudinal bars of the mesh, and the return wheel feeds roving strands used for transverse rods in the direction opposite to the movement of the manufactured mesh. The technological line contains a separator designed to split a flow of roving strands used for transverse rods of the mesh into separate rods and to feed them into the FPR mesh forming and weaving unit equipped with a cutting mechanism. The technological line contains a separate periodic profile forming device that produces a stream of rods used for making transverse rods of the mesh. 2 subclaims of formula, 2 illustrations.

The invention refers to technological equipment used to produce FPR mesh for reinforcing concrete products, masonry and brickwork.

The patent RU 2394135 describes a technological line for the manufacture of FRP rebar mesh (it includes a roving rack with roving bobbins, levelling device, an annealing chamber, an impregnation unit with a tensioning device, a squeezing device, a forming unit, a spiral winding device, polymerisation chambers, a pulling device, cutting unit) includes a mesh forming unit that follows the spiral winding devices and consists of a conveyor, a stacker of longitudinal and transverse rods of the mesh and a device for pressing the point of intersection; meanwhile, the line contains spiral winding devices, the number of which is not less than the number of longitudinal rods. Transverse rods made of pre-made cured or uncured bars are taken from the stacker by clamps and are delivered by the conveyor to zones of contact with longitudinal rods.

The disadvantage of the described device is the necessity to use pre-made FRP rebars of a certain size as transverse rods that are loaded into the stacker, which requires periodic stopping of the line to refill the stacker.

A technical solution that most closely approaches the claimed technical solution is described by the patent RU 173663. A mesh formation and weaving unit of a non-metallic FRP rebar mesh production line follows a squeezing unit and consists of a stacker for transverse strands of roving and n gears with openings for passing two longitudinal strands of roving, moreover, mating gears are mounted on a frame by means of shafts and are connected to an electric motor causing their rotation, moreover, the number of n gears is equal to the number of cells in single row of the mesh. This assembly contains a device for feeding FRP rebar from a separate coil.

A disadvantage of the mentioned device is the need to feed into the FRP mesh forming and weaving unit of the technological line pre-made transverse rods coming from separate coils, which requires stops in line operation to replace the above-mentioned coils.

The technical result of the claimed invention is an increase in the degree of automation of the production process and the exclusion of technological stops for replacing materials used to produce transverse rods of FRP rebar mesh.

The technical result is achieved due to the fact that, in accordance with the claimed invention, the technological line for non-metallic FRP mesh production (that includes sequentially installed roving rack with bobbins of roving, an impregnation and pressing unit, a FRP mesh forming and weaving device, a polymerization chamber, a water cooling unit, a FRP mesh pulling unit and a cutting unit) has, installed behind the water cooling unit, a return wheel mounted on a frame which is able to receive one to six bars used as FRP mesh transverse rods that move parallel to the roving strands intended for longitudinal rods of the mesh, and the return wheel feeds roving strands used for transverse rods in the direction opposite to the movement of the manufactured mesh.

The technological line for FRP rebar mesh production contains a separator designed to split a flow of roving strands used for transverse rods of the mesh into separate rods and to feed them into the FPR mesh forming and weaving unit equipped with a cutting mechanism.

The technological line for FRP rebar mesh production contains a separate periodic profile forming device that produces a stream of rods used for making transverse rods of the mesh.

The claimed production line allows the production and processing of roving strands intended for the manufacture of longitudinal and transverse rods of a non-metallic FRP rebar mesh, simultaneously and on the same production line, meanwhile, the roving strands for the manufacture of longitudinal rods are fed into the FRP mesh forming and weaving unit in the form of a semi-finished product that has not undergone heat treatment, while the strands for the manufacture of transverse rods are preliminarily heat-treated in the polymerization chamber and enters the FRP mesh forming and weaving unit in the form of a hardened, but not completely polymerized FRP rod, which is ensured by introducing a return wheel receiving the flow of bars that have passed all the necessary stages of processing and are later used for transverse rod production, a separator has been added, it is able to split the flow of roving rods into separate bars used for transverse rod production, accumulate them and feed them to the FRP mesh forming and weaving unit, thus eliminating the need to use pre-made rebar coils used as transverse rods for FRP mesh production, that way eliminating the need to stop production to replace the coils and increasing the degree of automation of the production process. A separate periodic profile forming device used for transverse rods allows to pre-make streams of bars used for transverse rod production.

Tests have shown that the claimed technological line provides continuous production of FRP rebar mesh (for 12 hours or more) without technological stops for material replacement.

The logic of the claimed invention is explained by the figures:

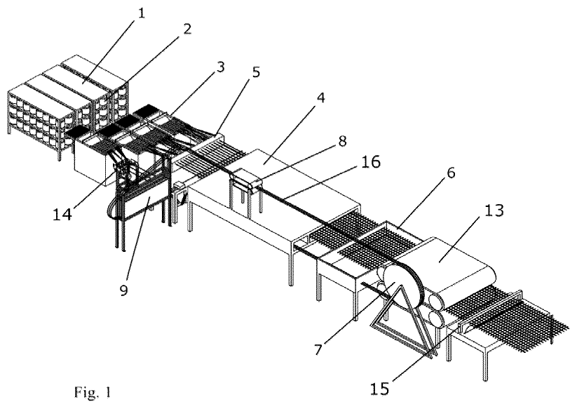

FIG. 1 shows a schematic diagram depicting arranged units of the technological line used for the manufacture of non-metallic FRP rebar mesh.

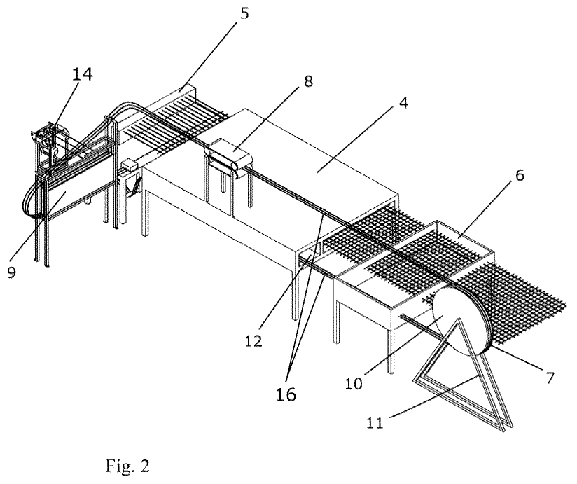

FIG. 2 shows a section of the line producing and feeding bars used for transverse rods into the FRP mesh forming and weaving device.

The technological line for the production of non-metallic FRP mesh includes sequentially installed roving rack (1) with roving bobbins (2), an impregnation and pressing unit (3), a polymerization chamber (4), a FRP mesh forming and weaving unit (5), a water cooling unit (6), a return wheel (7), a cross bar pulling unit (8), a separator (9) able to split the stream of bars used for transverse rods and feed them into the FRP mesh forming and weaving unit (5) that is equipped with a cutting unit (not shown in the drawing); the return mechanism (7) is represented by a wheel (10) mounted on a frame (11); the line contains a FRP mesh pulling unit (13) and a periodic profile forming device (14) utilised for transverse rods and an automatic cutting unit (15) for cutting FRP mesh. The automatic cutting unit (15) is followed by a device packing FPR mesh into rolls (not shown in the drawing). Bars used for transverse rods are produced and fed into a separate stream (16).

The cross bar pulling unit (8) FRP mesh pulling unit (13) may be of a track, roller or conveyor type. The separator (a separator of transverse roving rod stream) can shaped as a frame metal structure with a cover consisting of four walls between which bars for transverse rods are received and stacked, moreover, the bars for transverse rods are in such a way that each bar is isolated from another, for example, by the walls. In each section of the separator, transverse roving rod of sufficient length are laid and accumulated to be fed into the FRP mesh forming and weaving unit. Accumulation is ensured by uninterrupted operation of the cross bar pulling and by the FRP mesh forming and weaving unit alternately taking/pulling the rods from each stream.

The separator for the cross rod roving streams, other than the above embodiment, may be in the form of guide profile tubes, guide rollers or systems thereof, or otherwise.

The return wheel is a separate unit consisting of a wheel mounted on bearings positioned on a frame constructions with a steel sheet on the radial and lateral surfaces, the frame may be made of a pipe profile. The wheel has a width sufficient to receive from one to six (preferably three) streams of bars for transverse rods. The main function of the return wheel is to reverse the flow of the FRP mesh transverse in the direction opposite to the movement of the manufactured FRP mesh and to feed aforementioned flow into the pulling unit. The FRP mesh and transverse rod pulling unit can be of step, conveyor, track or roller type.

The roving streams intended transverse rod production move down the line faster than the FRP mesh. The roving streams intended for transverse rod production pass through a separate section (12) of the polymerization chamber (4) or, alternatively, through a separate polymerization chamber with the temperature that is 80-170° C. higher than in the main section of the polymerisation chamber (4) (depending on the rod diameter). Higher temperature in the above-mentioned separate section of the polymerization chamber ensures a necessary heat treatment of transverse rods that are moving through the units of the line at a higher speed.

Roving bobbins are arranged on a roving rack, from there roving strands are pulled through the impregnation and pressing unit where they are impregnated with a binder compound, then a portion the roving strands are joined in bundles (inside the FRP forming and weaving unit) to make longitudinal rods, meanwhile, the remaining roving strands pass through a separate impregnation and pressing unit and, preferably, through a separate periodic profile forming device, wherein it is assembled into at least one outmost stream of roving (preferably, into three streams) utilised transverse rod production. Further, through an open section of the weaving unit, roving rods enter the polymerization chamber immediately following the weaving unit, in particular, a separate section thereof, and further into the water cooling unit, from where the stream is fed onto the return wheel, from which it is fed through the pulling unit to the separator and further into the FRP mesh forming and weaving unit. Thereafter, the formed FRP mesh goes through all the stages of FRP rebar production. Due to the fact that the transverse rod, before entering the FRP mesh forming and weaving unit, has not been fully polymerized, the final polymerisation of longitudinal and transverse rods of the FRP mesh takes place simultaneously. Options of the practical application are not limited to the mentioned above; moreover, the components and units of the claimed technological line may be added, rearranged, joined or combined for other types of applications.

We claim:

1. A technological line for non-metallic FRP mesh production that includes sequentially installed roving rack with roving bobbins, an impregnation and pressing unit, a FRP mesh forming and weaving unit, a polymerization chamber, a water cooling unit, a FRP mesh pulling unit, a cutting unit and that is distinguished by a return wheel following the water cooling unit, the return wheel is mounted on a frame and is able to receive one to six streams of roving bars utilised for the production of FRP mesh transverse rods and moving parallel to the roving bars from which longitudinal rods are produces, the return wheel feeds the roving bars used for transverse rods in the direction opposite to the movements of the manufactured mesh.

2. The technological line for non-metallic FRP rebar mesh production manufactured in accordance with item 1 is distinguished by a separator that splits the flow of roving bars used to transverse rod production into individual bars and feeds them into the FRP mesh forming and weaving device equipped with a cutting unit.

3. The technological line for non-metallic FRP rebar mesh production manufactured in accordance with item 1 is distinguished by a separate periodic profile forming device producing a flow of bars used to manufacture transverse rods of FRP mesh.
